(19) United States
(12) Patent Application Publication
(10) Pub. No.: US 2019/0066311 A1
(43) Pub. Date: Feb. 28, 2019

(54) OBJECT TRACKING

(71) Applicant: Microsoft Technology Licensing, LLC, Redmond, WA (US)

(72) Inventors: Gustav Träff, Sodra Sandby (SE); Johan Windmark, Lund (SE)

(21) Appl. No.: 15/691,008

(22) Filed: Aug. 30, 2017

(51) Int. Cl. G06T 7/246; G06T 7/73; G06K 9/62; G06T 7/90

(52) U.S. Cl. CPC G06T 7/248; G06T 7/74; G06T 7/251; G06K 2209/21; G06K 9/6202; G06T 7/90; G06T 2207/10024; G06T 7/75

(57) ABSTRACT

A score is computed of a first feature for each of a plurality of pixels in a current image of a sequence of images, the sequence of images depicting a moving object to be tracked. A score of a second feature is computed for each of the plurality of pixels of the current image. A blending factor is dynamically computed according to information from previous images of the sequence. The first feature score and the second feature score are combined using the blending factor to produce a blended score; and a location in the current image is computed as a tracked location of the object depicted in the image, on the basis of the blended scores.

### BACKGROUND

Where a sequence of images, such as frames of a video, depict a scene containing a moving object, there is often a need to track the location within each frame which depicts the object. This is useful for many applications such as robotics, medical image analysis, gesture recognition, surveillance and others. Many of these applications use real time operation so that object tracking is to be performed as quickly and as efficiently as possible, and with good accuracy.

The embodiments described below are not limited to implementations which solve any or all of the disadvantages of known object tracking systems.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

A score is computed of a first feature for each of a plurality of pixels in a current image of a sequence of images, the sequence of images depicting a moving object to be tracked. A score of a second feature is computed for each of the plurality of pixels of the current image. A blending factor is dynamically computed according to information from previous images of the sequence. The first feature score and the second feature score are combined using the blending factor to produce a blended score; and a location in the current image is computed as a tracked location of the object depicted in the image, on the basis of the blended scores.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of an object tracking system using dynamic feature blending;

FIG. 2A is a schematic diagram of a first image of a sequence depicting a moving wand;

FIG. 2B is a schematic diagram of a last image of a sequence depicting a moving wand;

FIG. 2C is a schematic diagram of an object to be tracked from the image of FIG. 2A;

FIG. 2D is a schematic diagram of a search region in the image of FIG. 2A;

FIG. 2E is a schematic diagram of the likelihood of each pixel's color, in the search region of FIG. 2D, belonging to the tracked object in FIG. 2C;

FIG. 2F is a schematic diagram of a response obtained using template matching with the search region of FIG. 2D;

FIG. 2G is a schematic diagram of a response obtained using a color feature derived from FIG. 2E;

FIG. 2H is a schematic diagram of a response obtained using a blend of the color feature and the template matching with the search region of FIG. 2D;

FIG. 3A is a schematic diagram of an object to be tracked from the image of FIG. 2A;

FIG. 3B is a schematic diagram of another search region from an image of the sequence of images;

FIG. 3C is a schematic diagram of the likelihood of each pixel's color, in the search region of FIG. 3B, belonging to the tracked object in FIG. 2C;

FIG. 3D is a schematic diagram of a response obtained by applying a template feature to the search region of FIG. 3B;

FIG. 3E is a schematic diagram of a response obtained using a color feature derived from FIG. 3C;

FIG. 3F is a schematic diagram of a response obtained by applying a blend of a color feature and a template feature to the search region of FIG. 3B;

FIG. 4 is a graph of features scores per frame of the sequence of image frames depicting a moving object illustrated in FIG. 2A and FIG. 2B;

FIG. 5 is a flow diagram of a method of operation at an object tracker such as that of FIG. 1;

FIG. 5A is a flow diagram of a method of computing the feature models used in the object tracker;

FIG. 6 is a flow diagram of a method of computing a template feature;

FIG. 7 illustrates an exemplary computing-based device in which embodiments of an object tracker are implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example are constructed or utilized. The description sets forth the functions of the example and the sequence of operations for constructing and operating the example. However, the same or equivalent functions and sequences may be accomplished by different examples.

In order to track an object depicted in a sequence of images, it is possible to compute a feature of the depicted object and then search for that feature in images of the sequence. Where the feature is good at describing the object as it is depicted, and differentiating it from the background in all the images of the sequence then it is possible to track the object well. However, in practice it is difficult to find such features which are computable in real time. This is because there are generally many changes in the way the object is depicted through the sequence of images over time, such as due to changes in lighting conditions, shading, changes in the relative position of the object with respect to other objects in the scene, changes in the orientation of the object, partial occlusion of the object and other factors. Object tracking often fails when tracking non-rigid objects that change appearance.

In order to improve quality of object tracking, more than one feature is used to track the object depicted in the sequence of images. By using more than one feature, the combined performance is better since the different features are influenced differently by changes in the way the object is depicted in image sequence; if one feature performs poorly there is often another feature which performs well. Using more features increases the amount of computation and so increases the amount of time and computational resources needed. However, it is possible to compute the features in parallel and/or to reuse parts of computations between features. Another problem is how to combine the results from the different features. The features may be combined using fixed proportions. For example, in a given application domain, it may be found empirically that object tracking using a color feature is successful most of the time and that otherwise object tracking using a histogram of gradients feature gives good working results. In this case the results from the different features may be combined by using a weighted aggregation where the weights are fixed so that the color feature is dominant. This allows the histogram of gradients feature to influence the results but even so, where the color feature fails, the histogram of gradients feature is still outweighed by the color feature and it is difficult to obtain accurate object tracking.

In various embodiments described herein there is a way of combining the results from the different features using a dynamically computed blending factor. The blending factor takes into account information from previous images in the sequence, in order to compute an indication of how confident the object tracker is that a particular type of feature is a good predictor of the current object location. Using the confidence information the blending factor is adjusted dynamically so that the proportion or influence of the different features is controlled relative to one another. In this way, accurate object tracking is achieved in an extremely efficient manner.

Examples of various features which may be used in the object tracking system described herein are now given, although it is noted that these examples are not intended to limit the scope of the technology and other types of features or combinations of features may be used.

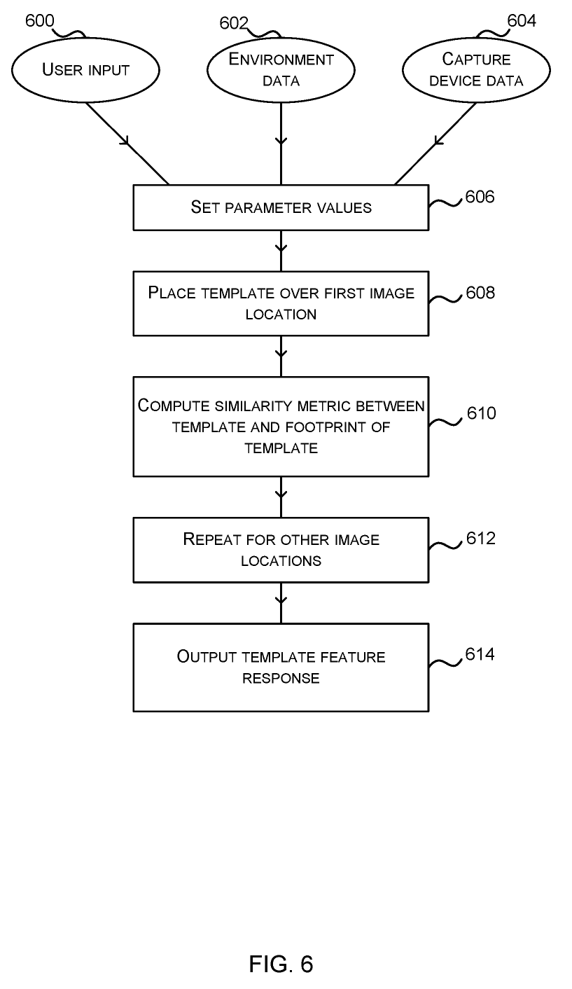

A template matching feature takes a region of an image depicting the object to be tracked and searches other images of the sequence to find regions similar to the template in order to track the object. A template is a contiguous region of image elements such as pixels or voxels and is typically smaller than the image. However, template matching gives poor results in some situations, such as where non-rigid objects that change appearance are to be tracked, where the template includes some pixels which do not depict the object, or where there are changes in lighting levels in the scene or other changes which influence how well the template describes the depicted object. Template matching is described in more detail below with reference to FIG. 6.

A color feature takes a region of an image depicting the object to be tracked and computes a color statistic describing the color of that feature. Other images of the sequence are searched to find regions with a similar color statistic in order to track the object. The statistics may be a color histogram, a mean color, a median color or other color statistic. A color feature is more robust than a template feature against changes in appearance of non-rigid objects as long as the object contains the same colors during the time it is being tracked. However, it is found that such a color feature is not descriptive enough to be used alone. Such a color feature is less accurate than other types of features such as template features (described below) at estimating position of an object and is easily deceived by similar color distributions in the background or nearby objects.

A histogram of gradients feature takes a neighborhood of an image depicting the object to be tracked and computeoccurrences of gradient orientations in localized portions of the neighborhood. A histogram of gradients feature utilizes that the fact that local object appearance and shape within an image can be described by the distribution of intensity gradients or edge directions. The neighborhood is divided into small connected cells, and for the pixels within each cell, a histogram of gradient directions is generated. The histogram of gradients feature is the concatenation of these histograms.

A discriminative correlation filter is used as a feature in some cases. A discriminative correlation filter minimizes a least-squares loss for all circular shifts of positive examples and enables the use of densely-sampled examples and high dimensional feature images in real-time using the Fourier domain. The feature is applied on a search region to generate a response similar to that of a template matching feature.

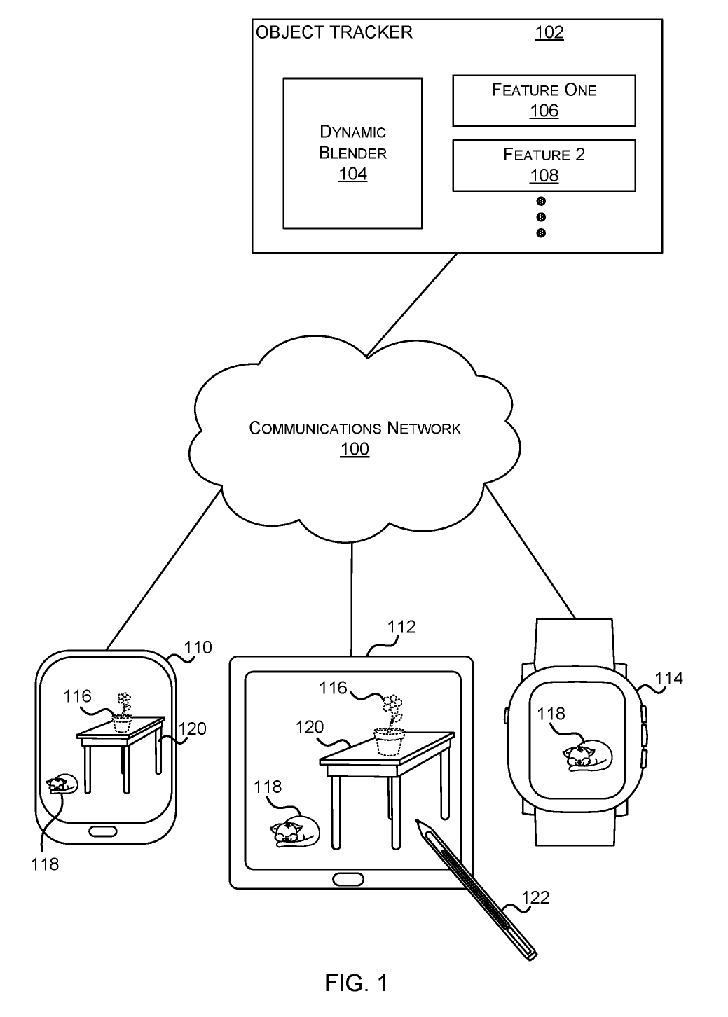

FIG. 1 is a schematic diagram of an object tracker 102 deployed at a computing device connected to a communications network 100. The object tracker 102 has a dynamic blender 104 for blending results of a plurality of features 106, 108 computed by the object tracker 102. In some examples the object tracker 102 is provided as a cloud service accessible to electronic devices such as smart phone 110, tablet computer 112, smart watch 114 or other electronic devices via communications network 100. In some cases the object tracker 102 is deployed at an electronic device such as smart phone 110 or another type of electronic device. The object tracker 102 is distributed between an electronic device 110, 112, 114 and a computing entity connected to communications network 100 in some examples.

In the example illustrated in FIG. 1 the smart phone has a video camera (not visible in FIG. 1) which has captured a video of a scene comprising a cat 118 sitting on the floor next to a coffee table 120. A user has annotated a frame of the video by drawing, using electronic ink, a plant in a plant pot 116 on the table 120. The video has been captured by a user holding the smart phone 110 panning the smart phone camera around the room whilst the cat 118 and table 116 remain static. The object tracker 102 is used to lock the electronic ink drawing of the plant pot 116 to the coffee table 120 in the video, despite the location of the coffee table 120 varying between frames of the video. For example, FIG. 1 shows a tablet computer 112 playing the video and with a different frame of the video visible than for the smart phone 110 of FIG. 1. Although the position of the table 120 in the frame is different than the position of the table 120 in the frame of the video shown on the smart phone 110 the object tracker 102 has successfully tracked the table 120 and locked the electronic ink plant pot 116 to table 120. FIG. 1 also shows a smart watch 114 displaying another frame of the video in which the cat 118 is visible but where the table 120 is outside of the field of view. In this case the electronic ink plant pot 116 is not visible since it is locked to the table 120 and the table 120 is outside the field of view. The object tracker computes a plurality of features of the surface of the table 120, such as a template matching and a color probability feature (or other features), from a given frame of the video. The object tracker searches subsequent frames of the video by computing the feature values and combining the results using a dynamically computed blending factor. In this way the object tracker is able to track the surface of the table 120 and lock the electronic ink plant pot 116 to the tracked surface of the table. The blending factor varies from frame to frame of the video so that when one of the features is performing poorly its influence is reduced, whereas a feature which is performing well has its influence boosted.

Although FIG. 1 gives an example of tracking an object in a video other applications of object tracking are used in some cases. These include tracking a person depicted on a web camera signal, tracking a body organ on a medical image, tracking a weather system on a meteorological data system, tracking a hand depicted in a depth camera signal, or tracking other objects in sequences of images whether there is motion, either from motion of the object or from motion of the camera.

The object tracker 102 is computer implemented using any one or more of: software, hardware, firmware. Alternatively, or in addition, the functionality of the object tracker 102 is performed, at least in part, by one or more hardware logic components. For example, and without limitation, illustrative types of hardware logic components that are optionally used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

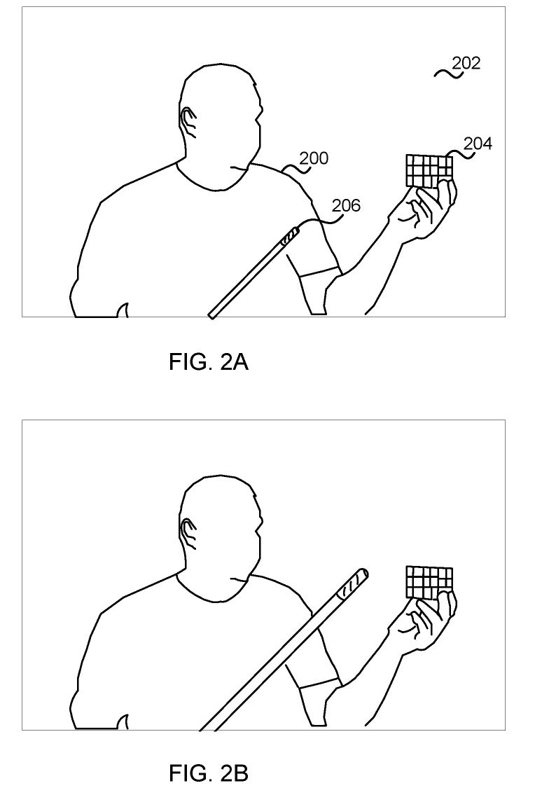

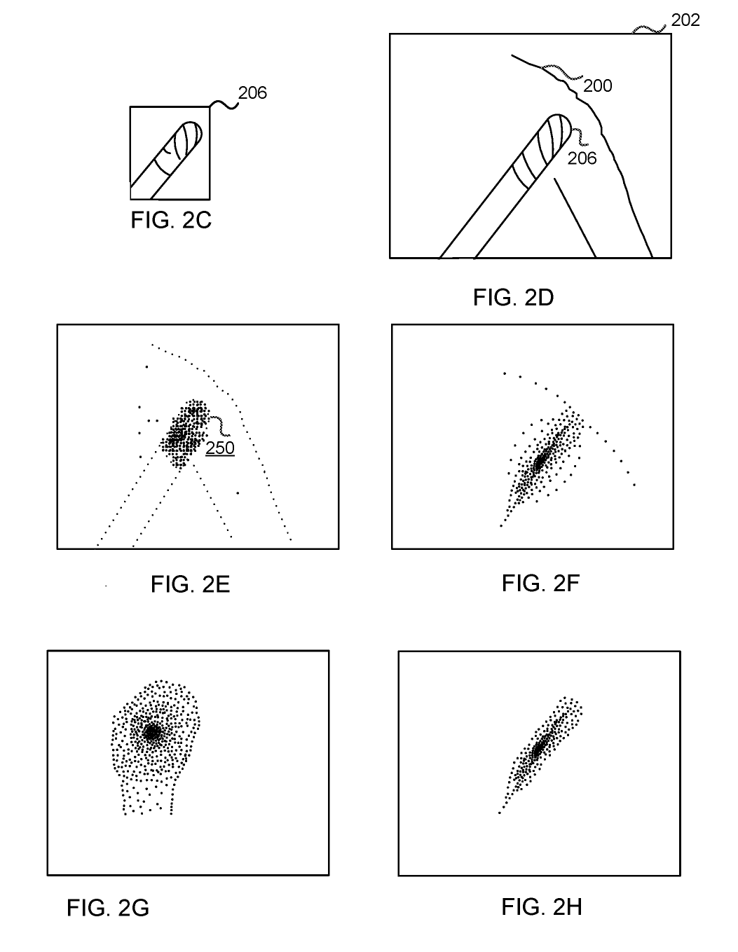

FIG. 2A is a schematic diagram of a first image of a sequence of images depicting a moving object and FIG. 2B is a schematic diagram of the last image of the sequence. A person 200 in the scene depicted in the image sequence is holding a cube 204 in one hand and a wand 206 in the other hand. The person moves the wand 206 towards the cube 204 during the sequence whilst keeping the cube 204 static. Suppose that the object tracker 102 has the task of tracking a tip of the wand 206 through the image sequence.

The object tracker has an object region such as that of FIG. 2C from one of the images of the sequence and has to track this region in the other images of the sequence. The object region is a region of image elements such as voxels or pixels the majority of which depict the object to be tracked. In various examples the object region is a rectangular or cuboid region but this is not essential as any contiguous region of image elements having a regular geometric shape or an irregular shape may be used.

In some cases the object region is automatically computed by the object tracker 102. For example, the object tracker detects an object of focus in one of the images and computes a bounding box around the object of focus. The region within the bounding box is then the object region. The object of focus is detected by segmenting a foreground region of the image using well known image segmentation processes. In other cases the object of focus is detected using knowledge of a focal region of an image capture device used to capture the image. In some cases the object of focus is detected using information about a gaze direction of a user detected using an eye tracker or in other ways. Combinations of one or more of these or other ways of detecting the object of focus are used in some cases. One common scenario is tracking a moving object detected by an underlying motion detection algorithm.

In some cases the object region is computed using user input. For example, a user draws a bounding box on an image to specify the object region. In some cases the user makes a brush stroke or draws electronic ink on an object depicted in the image and the whole object depicted in the image is selected as the object region. Interactive or guided image segmentation is used in some cases to segment the object.

FIG. 2D shows a search region within the image depicted in FIG. 2A. The object tracker computes the search region as a specified bounding box or other specified region around an initial estimate of the location of the depicted tracked object in the image. The initial estimate is obtained from an interpolation of the location of the tracked object depicted in a previous image of the sequence, or from an estimated computed using one or more of the features mentioned above.

FIG. 2E shows a target probability map computed from color histograms given the search region of FIG. 2D and the object region of FIG. 2C. The target probability map comprises a numerical value at each pixel location where the numerical value represents how likely the pixel is to depict the object being tracked (the wand tip). In the example of FIG. 2E the darker regions represent higher probability values. One example of computing the probability response R is:

$$R ( x , y ) = 255 * \frac{S * {H}_{fg} ( x , y )}{{H}_{fg} ( x , y ) + {H}_{bg} ( x , y )}$$

where x and y denote the location in the image region, S is a normalizing scale factor between the foreground and background histogram, H_{fg} the foreground histogram representing the object colors and H_{bg} the background histogram representing the background colors.

FIG. 2F shows a response map computed from the search region of FIG. 2D where each pixel location comprises a numerical value representing the result of computing a template feature. The object region of FIG. 2C is centered on each of the pixel locations of the search region of FIG. 2D in turn. A similarity metric is computed between the object region and the pixels of the search region it overlies and the resulting numerical value is placed at the corresponding pixel location of the response map. Any suitable similarity metric is used such as a normalized cross correlation, sum of squared differences, or other similarity metric. It is seen from FIG. 2F that the response map from the template feature is strong around the wand tip but that it also extends along the wand length and includes a weak response along the contour of the person's shoulder.

FIG. 2G shows a response map computed from the search region of FIG. 2D where each pixel location comprises a numerical value representing the result of computing a color feature derived from the color probability in FIG. 2E. In this case the feature response of FIG. 2G is created by sliding an averaging filter with a size related to the object dimensions in FIG. 2C over each pixel in the computed color probability region of FIG. 2E. This gives a response map of FIG. 2G created such that the final result has the same dimensions as the template feature response map in FIG. 2F. FIG. 2G shows that the color response is strong over the wand tip but is also strong around adjacent regions because it has a wide peak.

FIG. 2H shows the result of blending the response maps of FIG. 2F and FIG. 2G using a dynamic blending factor as described herein. It is seen that the blended response is more accurate than the response of FIG. 2F alone or the response of FIG. 2G alone.

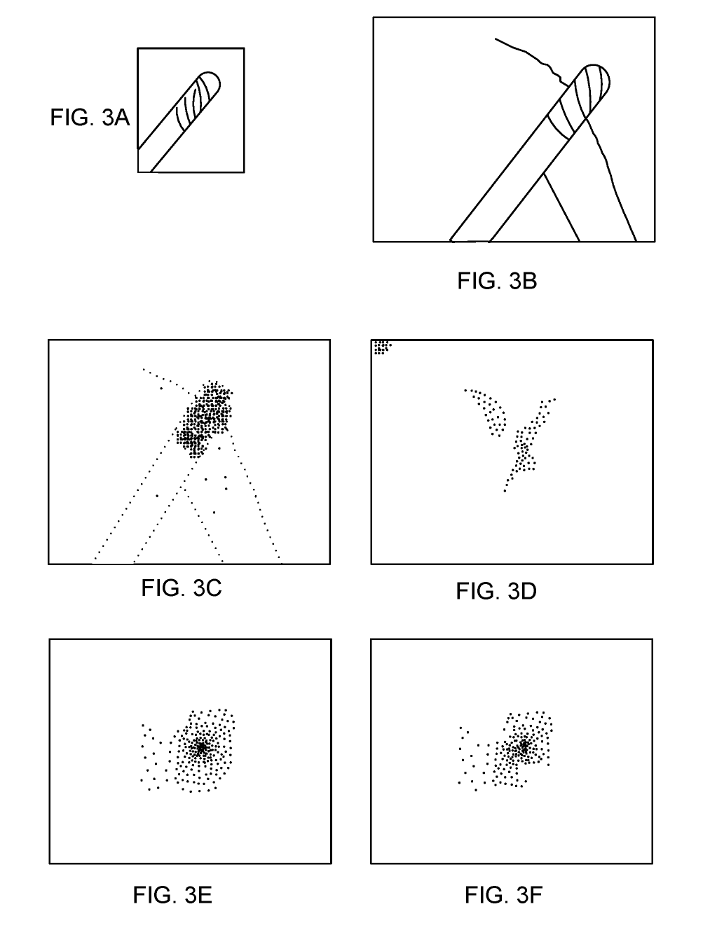

FIG. 3A shows the object region and is identical to FIG. 2C and is repeated for ease of comparison with FIGS. 3B to F. FIG. 3B is another example of a search region, this time for an image which is subsequent to image FIG. 2A in the sequence since the wand tip has moved so that it overlies a background wall in the scene rather than the person's shoulder as in FIG. 2D and where the background wall has a color which is different from a color of the person's shoulder. The target probability from the color feature is shown in FIG. 3C and indicates that the color feature is good at detecting the wand tip.

FIG. 3D shows a response map obtained from the template feature using the region of FIG. 3A as the template to search the region indicated in FIG. 3B. It is seen that the response is vague and ill-defined because the template includes shoulder background which is not present in FIG. 3B around the wand tip. FIG. 3E shows the response map obtained from the color feature in the same manner as described for FIG. 2G. It is seen that the response is strong over the wand tip (since the wand tip has not changed color) but is also strong around adjacent regions. This illustrates how the template matching feature performs poorly in some situations whereas the color feature performs reasonably well in the same situation. A blend of the responses of FIGS. 3D and 3E produces the result shown in FIG. 3F which is better than the responses of FIG. 3D or 3E alone. The adaptive process detects that the template feature produces an unreliable response and increases the blend level to include more of the color feature response. As a result the fused response of FIG. 3F is still accurate and the position of the wand tip is reliably estimated.

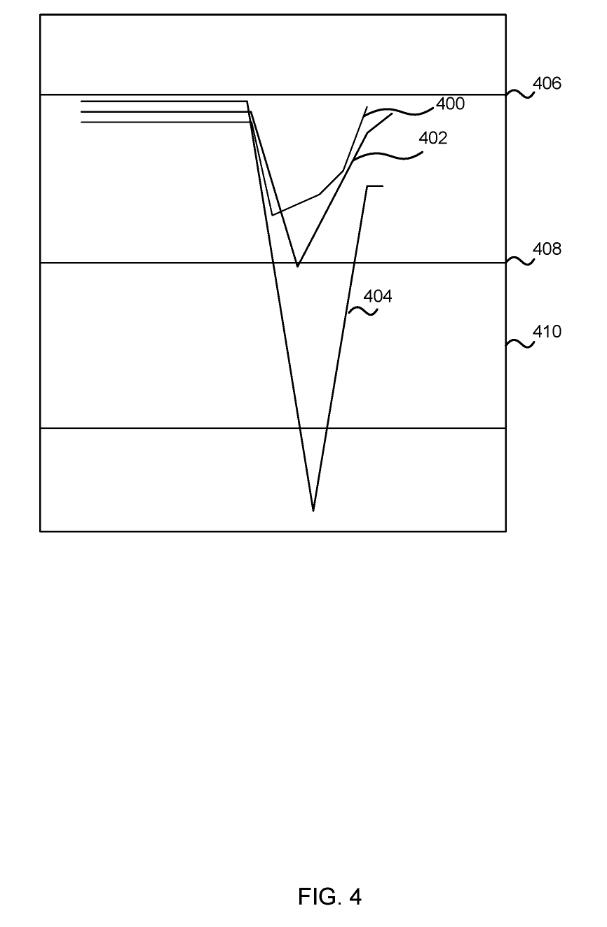

FIG. 4 is a graph of the magnitude of the response values (y axis) for each image of the image sequence (x axis). The response values are normalized between one (represented by line 406) and zero, so that line 408 represents a response magnitude of around 0.333 and line 410 represents a response magnitude of around 0.666. The image sequence is the same as the one described above with reference to FIGS. 2A and 2B. The response values for the template feature are shown in line 404, the response values for the color feature are shown in line 400 and the response values for the blended response are shown in line 402. It is seen that the fused response 402 takes advantage of the fact that the color feature 400 is more reliable and handles the difficult part of the sequence before the template feature 404 recovers. Even though the maximum response from the color feature is higher than the template feature, it is beneficial to include the template feature to some degree. This is especially the case when the template feature has recovered is the template feature becomes the preferred feature since the template feature is more discriminative and position accurate than the color feature.

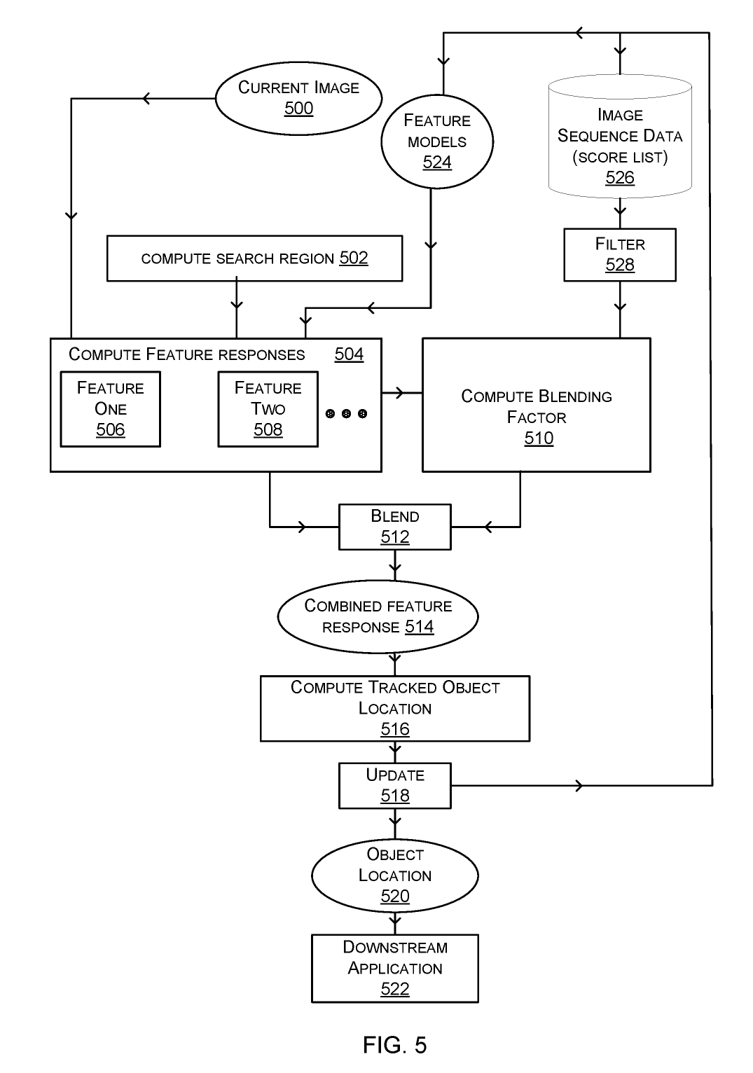

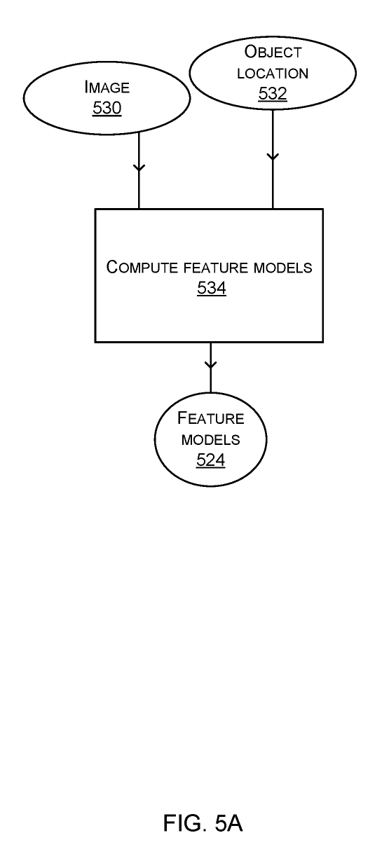

FIG. 5 is a flow diagram of a method at an object tracker such as that of FIG. 1. The object tracker receives 500 a current image where the location of the object being tracked is unknown. The object tracker computes 502 a search region in the current image by interpolating a position of the object depicted in the image sequence known from earlier images of a sequence of images comprising the current image. Given the search region the object tracker computes 504 a plurality of feature responses including at least feature responses for feature one 506 and feature two 508 of the search region. Feature one and feature two are different from one another and are any of the features described above. Feature one and feature two are computed in parallel in some examples. In some examples, where parts of the computation of a feature are re-usable these are reused between features or between computation of the same feature for different image locations in the search region. A feature response comprises a plurality of numerical values computed by applying a feature model to the search region. The object tracker has access to a plurality of stored feature models 524 such as color feature models, template feature models and other types of feature model such as for the types of features mentioned earlier in this document. An example of a color feature model is a foreground and background color histogram and an example of a template feature model is a bitmap of the object region such as that of FIG. 2C. A feature model is data describing the object depicted in at least one of the images, where the description uses the particular feature concerned.

In parallel with computation of the features, the object tracker computes a blending factor 510. The blending factor is computed once per search region using information about previous images in the sequence. The information is obtained from a store of image sequence data 526 at the object tracker or at a location accessible to the object tracker. In some cases the information is filtered 528 to remove information about previous images in the sequence where the object was not depicted and/or was not accurately tracked. Preferably, the information from previous images of the sequence is from a sequence having a duration from about 200 milliseconds to about 10 seconds as this is found to give good working results empirically.

For a given location in the feature responses the values of the two or more features 506, 508 are aggregated. The aggregation is done by blending the values 512 according to the computed blending factor. The aggregation is a summation, average, multiplication or other aggregation. This process is repeated to produce a blended response map such as those indicated in FIGS. 2H and 3F. Given the blended response map the object tracker computes 516 a tracked object location on the basis of the values in the blended response map. For example, by finding a location in the blended response map which is at a center of a region of optimum response values, or which is an optimum response value.

The object tracker updates 518 the store of image sequence data 526 by adding the computed location of the tracked object for the particular image of the image sequence. In addition, the object tracker updates 518 the feature models 524 using the computed location of the tracked object and the particular image of the image sequence. Note that it is not essential to carry out update operation 518 and also that it is possible to update either the store of image sequence data 526 or the feature models 524 or both. Updating one or both of the feature models is found to give improved accuracy of object tracking as compared with not making any updates to the feature models.

To update 518 the store of image sequence data the object tracker adds the computed location of the tracked object for the particular image of the image sequence to a score list or other data structure held in memory or other store 526. To update the feature models 524 the object tracker computes data describing the object depicted in the current image using the feature to create a new feature model. The new feature model replaces a previous feature model or is stored in addition to previous feature models 524. In the case of a color feature model comprising a foreground color histogram and a background color histogram, the object tracker extracts a region around the current tracked object location in the current image. It computes a foreground histogram of the colors of the pixels in that extracted region. It computes a background histogram of the colors of the pixels in the remainder of the current image. These histograms are then stored together as a feature model. In the case of a template feature model the object tracker extracts a region around the current tracked object location in the current image and stores it as a bitmap.

If the tracked object is not found in the current image, because it is occluded or has moved out of the field of view of the camera or cannot be detected using the features, the object tracker takes this into account in the update 518 operation. (However, it is not essential to do this.) For example, in the case of the color feature model, the foreground histogram and/or background histogram are not updated. Alternatively the foreground and/or background histogram are updated but the result is capped or adjusted, since it relates to an image which does not depict the object being tracked. In the case of the template feature model the bitmap is not updated or is updated in a capped manner or in a manner which is weighted so that little change results.

The object location 520 of the tracked object in the image is output to a downstream application 522. In some cases the downstream application is a tool for annotating video with electronic ink and here the information about the location of the object depicted in the image, which is a video frame in this case, is used to update electronic ink so that it is rendered on a display over the video frame so as to appear locked to the depicted object.

In some cases the downstream application is a robot which uses the information about the location of the depicted object in the image to compute a location of the real object in the robot's environment so that the robot is able to avoid or interact with the real object.

FIG. 5A is a flow diagram of a method of computing the feature models 524 used in the object tracker. Given an image 530 such as a current image, the object location 532 is known. The object location is the location in the current image of the depiction of the object being tracked and this object location is known because it has been computed by the object tracker using the process of FIG. 5 or because it has been obtained from another source. The object tracker computes 534 one or more feature models from the image 530 and object location 532. For example, to compute a color feature model the object tracker extracts a region of specified size around the object location in the image. It then computes a foreground and a background color histogram as described above. In the case of a template feature model the object tracker computes a bitmap from the image 530 around the object location. The resulting feature models 524 are stored and available to the object tracker for use in the object tracking process of FIG. 5.

More detail about the blending factor and how it is computed is now given.

In an example, a confidence factor is computed for each feature and these confidence factors are used to compute the blending factor as now described. In an example, the confidence factor is expressed as:

Cₖ(t)=Pₖ(t)*{square root over ((Mₖ(t)/μₖ(t))}

Where Cₖ is the confidence of feature k at time instance t where time instance t corresponds to one of the images of the sequence. The symbol Pₖ denotes the currently selected normalized peak response which is the normalized maximum response value at the most recent tracked object location in the image sequence. The symbol Mₖ denotes the raw peak response which is the maximum response value, before normalization, at the most recent tracked object location in the image sequence. The symbol, μₖ denotes the mean of the tracked object locations in the previous images and k is the feature number. In some examples, the mean μₖ is computed from the filtered data so it excludes data from images where object tracking failed as described above with reference to FIG. 5. The confidence factor Cₖ is expressed in words as, the confidence that feature k is able to detect the tracked object location in the image captured at time t within the sequence of images, is equal to the current normalized estimate of the tracked object location times the square root of the current estimate of the tracked object location divided by the mean of the tracked object locations in the previous images. Note that the mean of the tracked object locations in the previous images is replaced by another statistic such as a median, mode, percentile or variance in some examples, where the statistic is any statistic which describes the tracked object locations in the previous images.

In an example, the blending factor is computed as:

$${a}_{k} ( t ) = \frac{{C}_{k} ( t )}{{\sum }_{i = 1}^{m} {C}_{i} ( t )}$$

Where m is the number of features to blend between. The blending factor is expressed in words as: the blending factor for feature k at the image captured at time t in the image sequence is equal to the ratio of the confidence factor for feature k to the sum of all the confidence factors of the available features. The blending factor is capped between about 0.2 and 0.8 in some examples because this ensures that the feature always has an impact on the final response and is found empirically to give good working results.

In some examples, the blended response is calculated as a linear combination as follows:

R(x,y)=a _{c}*R_{c}(x,y)+a _{T}*R_{T}(x,y)

Which is expressed in words as, the response at image location x,y is equal to the blending factor for feature c times the response from feature c at image location x,y plus the blending factor for feature T times the response from feature T at image location x,y. In a preferred example, the feature c is a color feature and the feature T is a template matching feature. This combination of features is found to give fast and accurate results and is operable at 300 frames per second on a standard personal computer without a graphics processing unit. Having said that, other combinations of features are possible.

Because the confidence factors (and so the blending factor) are computed using the mean of the tracked object location in the previous images, these factors take into account information from previous images of the sequence. In the example give immediately above a mean is used to capture the information about previous images of the sequence, however, it is also possible to use other statistics such as a median, mode, percentile, variance or other statistic. For example, the stored information comprises a first statistic describing a first feature score over the previous images of the sequence, and a second statistic describing a second feature score over the previous images of the sequence, and wherein the first and second statistic are selected from: mean, mode, median, percentile, variance.

The information about the previous images in the sequence which is used in the confidence factor comprises an estimate of the ability of the feature to indicate the current location of the object. This is because if the feature gives an estimate which is similar to the previous estimates it is likely to be a good indicator, and if it gives an estimate which begins to move away from previous estimates it is likely to be failing.

The information about the previous images which is used in the confidence factor and so in the blending factor is compact to store and fast to access from memory. The memory stores the information comprising, for individual images of the sequence, an estimate of the tracked object location in the image per feature. The estimates are stored in normalized form and/or in raw form (before normalization). In this way it is not necessary to store the complete images of the sequence and so efficiencies are gained.

In the example given above concerning the response computed from a color feature and a template matching feature there are only two types of feature. However, it is possible to have more than two types of feature. For example, there are three features in some examples. In this case the processor of the object tracker is configured to compute a score of a third feature for each of the plurality of pixels of the current image and to combine the first feature score, the second feature score and the third feature score to produce a blended score using at least one dynamically computed blending factor.

An example of computing a template matching feature is now given. This method is used by the object tracker in some examples. In this example, the similarity metric used by the template matching comprises a normalized cross correlation function which is modified to include at least one factor related to a statistic of both the object region and the current image. The factor influences how much discriminative ability the template matching process has. For example, the factor acts to penalize differences between the statistic of the object region and the current image so that if there are differences the similarity metric is lower. The statistic is a mean of an image quantity, or a standard deviation of an image quantity in some cases. The image quantity is intensity or another image quantity such as texture.

In some cases the at least one factor is computed as a function of the statistic of the object region and the statistic of the current image, and the function is parameterized. In some cases the function is parameterized by two parameters, a first one of the parameters controlling a range within which the function produces the value one, and a second one of the parameters controlling a rate at which the function produces a value smaller than one and moving towards zero. In some cases more than one factor is used and the factors are computed from parameterized functions.

In the example given above the blending factor comprises a blending factor component computed separately for each feature. This enables the blending factor to take into account differences between the features and gives good accuracy.

FIG. 6 is a flow diagram of a method of operation at the dynamic blender to compute a template feature response. In an optional operation, parameter values are set 606 and these are values of parameters used by the similarity metric. In some cases the values of the parameters are hard coded into the dynamic blender 104 in which case they are not set during operation of the process of FIG. 6. For example, the values of the parameters are selected through empirical testing and configured by an operator during manufacture of the dynamic blender 104.

In some cases the values of the parameters are computed by the dynamic blender 104 itself using data from one or more sources. Sources of information which may be used alone or in any combination include: user input 600, environment data 602 and capture device data 604. In the case of user input 600 a user is able to set the values of the parameters by selecting a value or a range of values in any suitable manner. In the case of environment data 602 the dynamic blender 104 has access to data about the environment in which the images and/or template were captured. A non-exhaustive list of examples of environment data is: light sensor data, accelerometer data, vibration sensor data. In the case of capture device data 604 the dynamic blender 104 has access to data about one or more capture devices used to capture images and/or template. A non-exhaustive list of examples of capture device data 604 is: exposure setting, focus setting, camera flash data, camera parameters, camera light sensor data.

Where the dynamic blender 104 uses environment data 602 and/or capture device data 604 to set the parameter values it uses rules, thresholds or criteria to compute the parameter values from the data. For example, where the environment data 602 is similar for the image and for the template the parameter values are set so that the normalization is “turned down” and the discriminative ability of the dynamic blender is “turned up”. For example, where the environment data 602 is different by more than a threshold amount for the image and the template, the parameter values are set so that the normalization is “turned up” and the discriminative ability is “turned down”.

The template is placed 608 over a first image location such as the top left image element (pixel or voxel) of the search region. The template is compared with the image elements of the search region which are in the footprint of the template. The comparison comprises computing 610 the modified normalized cross correlation metric. The resulting numerical value may be stored in a location of the response array which corresponds to the location of the first image element. The template is then moved to the next image location such as the next image element of the row and the process repeats 612 for the remaining image locations (such as all pixels or voxels of the image). This produces a template feature response such as that of FIG. 2F or 3D.

In some examples the process of FIG. 6 is modified to achieve efficiencies so that fewer computing resources are needed and/or so that the process is operable in real time using conventional computer hardware such as a smart phone or tablet computer. The object region and the current image are converted into the frequency domain by computing a Fourier transform of both. The Fourier transformed object region is then multiplied with the Fourier transformed current image (after normalization of both) in order to compute the similarity metric. The results of the multiplication are transformed using a reverse Fourier transform to give results in the spatial domain. A peak analysis is then done to find the optimal scoring image element location and thus the region in the current image which optimally matches the object region.

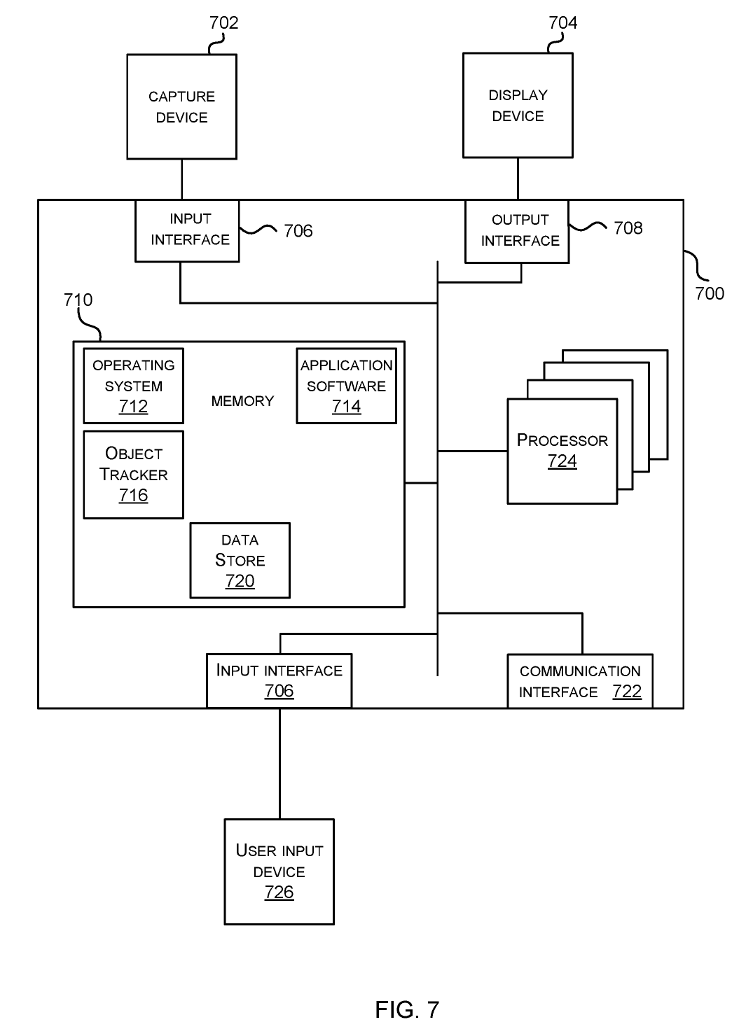

FIG. 7 illustrates various components of an exemplary computing-based device 700 which are implemented as any form of a computing and/or electronic device, and in which embodiments of an image processing with a template matching facility are implemented in some examples.

Computing-based device 700 comprises one or more processors 724 which are microprocessors, controllers or any other suitable type of processors for processing computer executable instructions to control the operation of the device in order to carry out image processing with template matching that has discriminative control. In some examples, for example where a system on a chip architecture is used, the processors 724 include one or more fixed function blocks (also referred to as accelerators) which implement a part of the method of FIG. 5 or FIG. 6 in hardware (rather than software or firmware). A dynamic blender 716 at the computing-based device is able to match a template to an image as described herein. A data store 720 holds images, computed responses, parameter values, similarity metrics and other data. Platform software comprising an operating system 712 or any other suitable platform software is provided at the computing-based device to enable application software 714 to be executed on the device.

The computer executable instructions are provided using any computer-readable media that is accessible by computing based device 700. Computer-readable media includes, for example, computer storage media such as memory 710 and communications media. Computer storage media, such as memory 710, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 710) is shown within the computing-based device 700 it will be appreciated that the storage is, in some examples, distributed or located remotely and accessed via a network or other communication link (e.g. using communication interface 722).

The computing-based device 700 also comprises an input interface 706 which receives inputs from a capture device 702 such as a video camera, depth camera, color camera, web camera or other capture device 702. The input interface 706 also receives input from one or more user input devices 726. The computing-based device 700 comprises a an output interface 708 arranged to output display information to a display device 704 which may be separate from or integral to the computing-based device 700. A non-exhaustive list of examples of user input device 726 is: a mouse, keyboard, camera, microphone or other sensor. In some examples the user input device 726 detects voice input, user gestures or other user actions and provides a natural user interface (NUI). This user input may be used to change values of parameters, view responses computed using similarity metrics, specify templates, view images, draw electronic ink on an image, specify images to be joined and for other purposes. In an embodiment the display device 704 also acts as the user input device 726 if it is a touch sensitive display device. The output interface 708 outputs data to devices other than the display device in some examples.

Any of the input interface 706, the output interface 708, display device 704 and the user input device 726 may comprise natural user interface technology which enables a user to interact with the computing-based device in a natural manner, free from artificial constraints imposed by input devices such as mice, keyboards, remote controls and the like. Examples of natural user interface technology that are provided in some examples include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of natural user interface technology that are used in some examples include intention and goal understanding systems, motion gesture detection systems using depth cameras (such as stereoscopic camera systems, infrared camera systems, red green blue (rgb) camera systems and combinations of these), motion gesture detection using accelerometers/gyroscopes, facial recognition, three dimensional (3D) displays, head, eye and gaze tracking, immersive augmented reality and virtual reality systems and technologies for sensing brain activity using electric field sensing electrodes (electro encephalogram (EEG) and related methods).

Alternatively or in addition to the other examples described herein, examples include any combination of the following:

An image processing apparatus comprising:

a memory storing information about a sequence of images depicting a moving object to be tracked;

a processor configured to compute a score of a first feature for each of a plurality of pixels in a current image of the sequence;

the processor configured to compute a score of a second feature for each of the plurality of pixels of the current image;

the processor configured, for individual ones of the plurality of pixels of the current image, to combine the first feature score and the second feature score using a blending factor to produce a blended score; and

to compute a location in the current image as the tracked location of the object on the basis of the blended scores; wherein the blending factor is computed dynamically according to the information from previous images of the sequence.

The image processing apparatus described above wherein the information is about variation in the first feature score and variation in the second feature score over the previous images of the sequence.

The image processing apparatus described above wherein the information comprises an estimate of the ability of the features to indicate the current location of the object.

The image processing apparatus described above wherein the processor is configured to compute the score of the first feature using a first feature model and to compute the score of the second feature using a second feature model, and wherein the feature models are related to a location of the object depicted in one of the images.

The image processing apparatus described above wherein the processor is configured to update the feature models using the computed location and to use the updated feature models when computing the scores for a next image of the sequence.

The image processing apparatus described above wherein the memory stores the information comprising, for individual images of the sequence, an estimate of the tracked object location in the image per feature.

The image processing apparatus described above wherein the estimates are stored in normalized form as numerical values between zero and one.

The image processing apparatus described above wherein the information comprises a first statistic describing the first feature score over the previous images of the sequence, and a second statistic describing the second feature score over the previous images of the sequence, and wherein the first and second statistic are selected from: mean, mode, median, percentile, variance.

The image processing apparatus described above wherein the blending factor comprises a blending factor component computed separately for each feature.

The image processing apparatus described above wherein the blending factor component for feature k at the image captured at time t in the image sequence is equal to the ratio of a confidence factor for feature k to the sum of confidence factors of the available features.

The image processing apparatus described above wherein the confidence factor is computed as a current normalized estimate of the tracked object location times the square root of the current estimate of the tracked object location divided by a statistic describing the tracked object locations in the previous images.

The image processing apparatus described above wherein the processor is configured to dynamically compute the blending factor as a numerical value capped between about 0.2 and about 0.8.

The image processing apparatus described above wherein the processor is configured to compute a score of between two and ten features for each of the plurality of pixels of the current image and to combine, for each pixel, the feature scores to produce a blended score using at least one dynamically computed blending factor.

The image processing apparatus described above wherein the processor is configured to filter the information from previous images of the sequence to remove instances where object tracking failed.

The image processing apparatus described above wherein the information from previous images of the sequence is from a sequence having a duration from about 200 milliseconds to about 10 seconds.

The image processing apparatus described above wherein the first feature comprises values computed from template matching and the second feature comprises color values.

The image processing apparatus described above wherein the first feature and the second feature are based on one or more of: image intensities, colors, edges, textures, frequencies.

A computer-implemented method comprising:

computing a score of a first feature for each of a plurality of pixels in a current image of a sequence of images, the sequence of images depicting a moving object to be tracked;

computing a score of a second feature for each of the plurality of pixels of the current image;

dynamically computing a blending factor according to information from previous images of the sequence;

combining the first feature score and the second feature score using the blending factor to produce a blended score; and

computing a location in the current image as a tracked location of the object depicted in the image on the basis of the blended scores.

The method described above comprising storing, at a memory, information about the sequence of images depicting a moving object to be tracked.

One or more tangible device-readable media with device-executable instructions that, when executed by a computing system, direct the computing system to perform operations comprising:

computing a score of a first feature for each of a plurality of pixels in a current image of a sequence of images depicting a moving object to be tracked;

computing a score of a second feature for each of the plurality of pixels of the current image;

dynamically computing a blending factor according to an estimate of the relative ability of the features to indicate the current location of the object;

combining the first feature score and the second feature score using the blending factor to produce a blended score; and

computing a location in the current image as the tracked location of the object on the basis of the blended scores.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

This acknowledges that software is a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

1. An image processing apparatus comprising:
a memory storing information about a sequence of images depicting a moving object to be tracked;
a processor configured to compute a score of a first feature for each of a plurality of pixels in a current image of the sequence;
the processor configured to compute a score of a second feature for each of the plurality of pixels of the current image;
the processor configured, for individual ones of the plurality of pixels of the current image, to combine the first feature score and the second feature score using a blending factor to produce a blended score; and
to compute a location in the current image as the tracked location of the object on the basis of the blended scores; wherein the blending factor is computed dynamically according to the information from previous images of the sequence.

2. The image processing apparatus of claim 1 wherein the information is about variation in the first feature score and variation in the second feature score over the previous images of the sequence.

3. The image processing apparatus of claim 1 wherein the information comprises an estimate of the ability of the features to indicate the current location of the object.

4. The image processing apparatus of claim 1 wherein the processor is configured to compute the score of the first feature using a first feature model and to compute the score of the second feature using a second feature model, and wherein the feature models are related to a location of the object depicted in one of the images.

5. The image processing apparatus of claim 4 wherein the processor is configured to update the feature models using the computed location and to use the updated feature models when computing the scores for a next image of the sequence.

6. The image processing apparatus of claim 1 wherein the memory stores the information comprising, for individual images of the sequence, an estimate of the tracked object location in the image per feature.

7. The image processing apparatus of claim 6 wherein the estimates are stored in normalized form as numerical values between zero and one.

8. The image processing apparatus of claim 1 wherein the information comprises a first statistic describing the first feature score over the previous images of the sequence, and a second statistic describing the second feature score over the previous images of the sequence, and wherein the first and second statistic are selected from: mean, mode, median, percentile, variance.

9. The image processing apparatus of claim 8 wherein the blending factor comprises a blending factor component computed separately for each feature.

10. The image processing apparatus of claim 8 wherein the blending factor component for feature k at the image captured at time t in the image sequence is equal to the ratio of a confidence factor for feature k to the sum of confidence factors of the available features

11. The image processing apparatus of claim 8 wherein the confidence factor is computed as a current normalized estimate of the tracked object location times the square root of the current estimate of the tracked object location divided by a statistic describing the tracked object locations in the previous images.

12. The image processing apparatus of claim 1 wherein the processor is configured to dynamically compute the blending factor as a numerical value capped between about 0.2 and about 0.8.

13. The image processing apparatus of claim 1 wherein the processor is configured to compute a score of between two and ten features for each of the plurality of pixels of the current image and to combine, for each pixel, the feature scores to produce a blended score using at least one dynamically computed blending factor.

14. The image processing apparatus of claim 1 wherein the processor is configured to filter the information from previous images of the sequence to remove instances where object tracking failed.

15. The image processing apparatus of claim 1 wherein the information from previous images of the sequence is from a sequence having a duration from about 200 milliseconds to about 10 seconds.

16. The image processing apparatus of claim 1 wherein the first feature comprises values computed from template matching and the second feature comprises color values.

17. The image processing apparatus of claim 1 wherein the first feature and the second feature are based on one or more of: image intensities, colors, edges, textures, frequencies.

18. A computer-implemented method comprising:
computing a score of a first feature for each of a plurality of pixels in a current image of a sequence of images, the sequence of images depicting a moving object to be tracked;
computing a score of a second feature for each of the plurality of pixels of the current image;
dynamically computing a blending factor according to information from previous images of the sequence;
combining the first feature score and the second feature score using the blending factor to produce a blended score; and
computing a location in the current image as a tracked location of the object depicted in the image on the basis of the blended scores.

19. The method of claim 18 comprising storing, at a memory, information about the sequence of images depicting a moving object to be tracked.

20. One or more device-readable media with device-executable instructions that, when executed by a computing system, direct the computing system to perform operations comprising:
computing a score of a first feature for each of a plurality of pixels in a current image of a sequence of images depicting a moving object to be tracked;
computing a score of a second feature for each of the plurality of pixels of the current image;
dynamically computing a blending factor according to an estimate of the relative ability of the features to indicate the current location of the object;
combining the first feature score and the second feature score using the blending factor to produce a blended score; and
computing a location in the current image as the tracked location of the object on the basis of the blended scores.
